(19) United States
(12) Patent Application Publication
(10) Pub. No.: US 2025/0291297 A1
(43) Pub. Date: Sep. 18, 2025

(54) IMAGE FORMING APPARATUS

(71) Applicant: CANON KABUSHIKI KAISHA, Tokyo (JP)

(72) Inventors: TAKAO IZAKI, Shizuoka (JP); TOHRU SAITO, Shizuoka (JP)

(21) Appl. No.: 19/057,411

(22) Filed: Feb. 19, 2025

(30) Foreign Application Priority Data
Mar. 13, 2024 (JP) 2024-039387

(51) Int. Cl. G03G 15/00; G03G 15/20; G03G 21/16

(52) U.S. Cl. CPC G03G 15/80; G03G 15/2064; G03G 21/1647

(57) ABSTRACT

An image forming apparatus includes an apparatus body including a control unit, and a wiring member electrically connected to the control unit, the wiring member having a first connector provided at an end of the wiring member, and a unit including a second connector insertable into and removable from the first connector. The wiring member includes a fuse to be blown in accordance with a command from the control unit.

### BACKGROUND OF THE INVENTION

### Field of the Invention

The present disclosure relates to an image forming apparatus that forms an image on a recording material.

### Description of the Related Art

Japanese Patent Application Publication No. H04-131864 describes that when a connector of a charger and a connector of an apparatus body of an image forming apparatus are connected, a fuse attached to the charger is blown, so that a CPU of the apparatus body detects that a new charger is attached. Japanese Patent Application Publication No. 2019-101276 describes that a deterioration amount of a connector is determined based on the number of times a connector of a fixing unit and a connector of an apparatus body are inserted/removed and a situation at the time of insertion/removal (an insertion/removal speed or the like).

### SUMMARY OF THE INVENTION

The present invention provides an image forming apparatus of a new form having a configuration capable of detecting a state of a connector.

According to an aspect of the invention, an image forming apparatus includes an apparatus body including a control unit, and a wiring member electrically connected to the control unit, the wiring member having a first connector provided at an end of the wiring member, and a unit including a second connector insertable into and removable from the first connector, wherein the wiring member includes a fuse to be blown in accordance with a command from the control unit.

According to another aspect of the invention, an image forming apparatus includes an apparatus body including a control unit, and a first connector electrically connected to the control unit, and a unit attachable to and detachable from the apparatus body, the unit including a second connector insertable into and removable from the first connector, and a storage unit configured to store information related to a deterioration of the second connector, the storage unit being electrically connected to the control unit via the first connector and the second connector.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to a first embodiment.

FIG. 2 is a circuit diagram of the image forming apparatus according to the first embodiment.

FIG. 3A is an explanatory diagram of a cutoff element according to the first embodiment.

FIG. 3B is an explanatory diagram of the cutoff element according to the first embodiment.

FIG. 4 is a circuit diagram of a fusing circuit according to the first embodiment.

FIG. 5 is a flowchart illustrating a control method according to the first embodiment.

FIG. 6 is a circuit diagram of an image forming apparatus according to a second embodiment.

FIG. 7A is a perspective view illustrating a terminal of a drawer connector according to the first embodiment.

FIG. 7B is a perspective view illustrating a terminal of the drawer connector according to the first embodiment.

FIG. 8A is a cross-sectional view illustrating the terminal of the drawer connector according to the first embodiment.

FIG. 8B is a cross-sectional view illustrating the terminal of the drawer connector according to the first embodiment.

FIG. 8C is a cross-sectional view illustrating the terminal of the drawer connector according to the first embodiment.

FIG. 9 is a graph showing a change in resistance of an AC contact with respect to the number of times of insertion/removal of a connector.

FIG. 10 is a circuit diagram of an image forming apparatus according to a third embodiment.

FIG. 11 is a flowchart illustrating a control method according to the third embodiment.

FIG. 12 is a schematic diagram of an image forming apparatus according to a fourth embodiment.

FIG. 13 is a schematic diagram of the image forming apparatus according to the fourth embodiment.

FIG. 14A is an explanatory diagram of the image forming apparatus according to the fourth embodiment.

FIG. 14B is an explanatory diagram of the image forming apparatus according to the fourth embodiment.

FIG. 14C is an explanatory diagram of the image forming apparatus according to the fourth embodiment.

### DESCRIPTION OF THE EMBODIMENTS

Hereinafter, embodiments according to the present disclosure will be described with reference to the drawings.

### First Embodiment

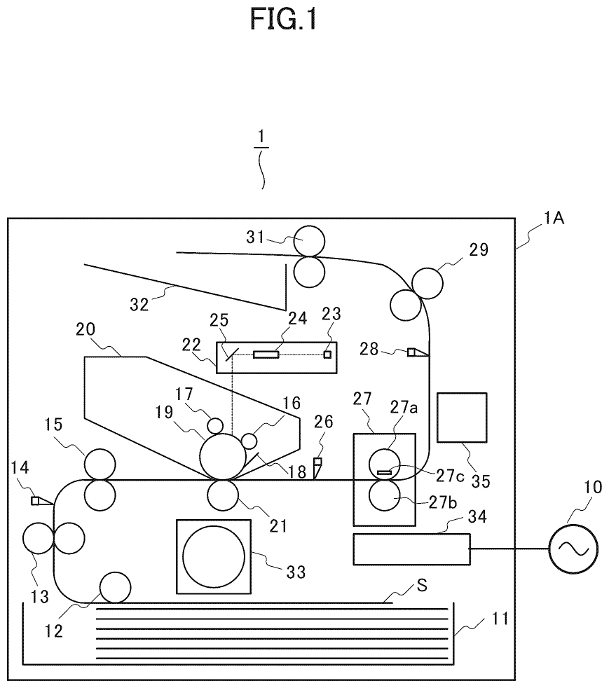

As a first embodiment, an embodiment in which a fuse is disposed on a wiring member (body cable) on an apparatus body side of an image forming apparatus will be described. First, an outline of an image forming apparatus will be described with reference to FIG. 1.

FIG. 1 is a schematic view illustrating a cross section of an image forming apparatus 1 according to the present embodiment. The image forming apparatus 1 is a monochrome laser beam printer using an electrophotographic technique. The image forming apparatus 1 forms an image on a recording material S based on, for example, image data received from the outside. As the recording material S (recording medium), various sheet materials that are different in size and material, such as paper such as plain paper and thick paper, a surface-treated sheet material such as coated paper, a sheet material having a special shape such as an envelope and index paper, a plastic film, and cloth, can be used.

The image forming apparatus 1 includes an apparatus body 1A, a process cartridge 20, a scanner unit 22, a transfer roller 21, a fixing device 27, a motor 33, a power supply device 34, and a control unit 35. Further, the image forming apparatus 1 includes a cassette 11, a feed roller 12, a conveyance roller pair 13, a registration roller pair 15, a conveyance roller pair 29, a sheet discharge roller pair 31, and a sheet discharge tray 32.

In the present embodiment, the apparatus body 1A includes a frame member constituting a frame body of the image forming apparatus 1 and a cover member constituting an exterior surface of the image forming apparatus 1. That is, the apparatus body 1A includes a casing formed by the frame member and the cover member. The above-described elements (20, 21, 22, 27, 33, 34, 35, 13, 15, 29, 31) are attached to the apparatus body 1A, and are accommodated inside the apparatus body 1A during image formation. At least the process cartridge 20 and the fixing device 27 are detachable from the apparatus body 1A.

The process cartridge 20 is an example of an image forming unit that forms an image on the recording material S. The process cartridge 20 is a unit in which a photosensitive drum 19 serving as an image bearing member and at least one process member acting on the photosensitive drum 19 are integrated. The process member is involved in any of charging, exposure, development, transfer, and cleaning in the electrophotographic process. The process cartridge 20 of the present embodiment includes a charging roller 16 serving as a charging member, a developing roller 17 serving as a developing member, and a cleaning blade 18 serving as a cleaning member. In addition, a toner serving as a developer is accommodated in the process cartridge 20. Note that, instead of the process cartridge 20, a process unit having functions similar to those of the process cartridge 20 and fixed to the apparatus body 1A in a mode that does not assume attachment and detachment by a user may be used.

The scanner unit 22 is an example of an exposing unit that exposes the photosensitive drum 19. The scanner unit 22 includes a laser diode 23 that is a light source, and a polygon mirror 24 and a reflection mirror 25 constituting an optical system for scanning the surface of the photosensitive drum 19 using laser light. The exposing unit may be an LED exposing unit using LEDs arranged side by side in the main scanning direction of the photosensitive drum 19 as a light source.

The transfer roller 21 is a transfer member for transferring a toner image onto the recording material S. A transfer nip serving as a transfer portion where a toner image is transferred is formed between the transfer roller 21 and the photosensitive drum 19.

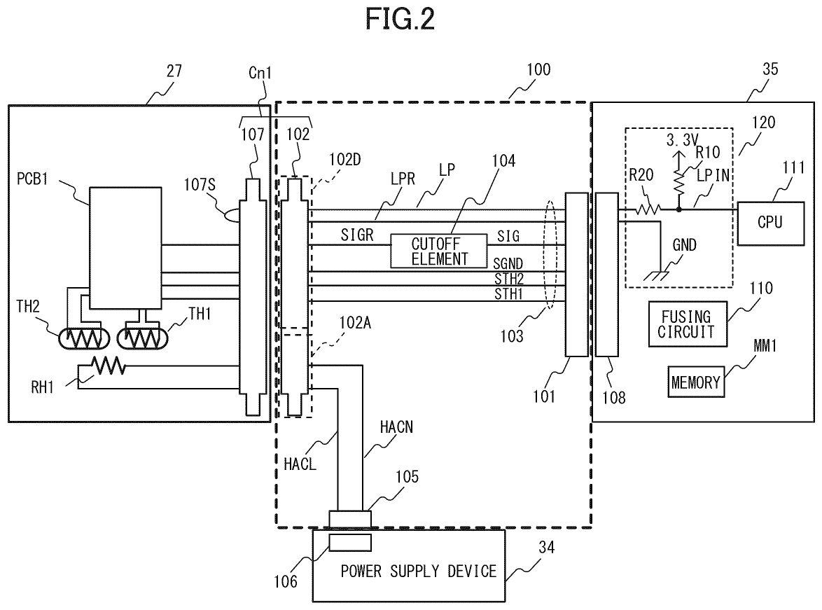

The fixing device 27 includes a heating member 27a (fixing member), a pressurizing member 27b abutting on the heating member 27a, and a heat source 27c that heats the heating member 27a. The fixing device 27 is an image heating device that heats and pressurizes a toner image on the recording material while conveying the recording material S nipped at a nip portion (fixing nip) between the heating member 27a and the pressurizing member 27b. The fixing device 27 is, for example, of a film heating type fixing device. The film heating type fixing device 27 includes a tubular film having flexibility as the heating member 27a, a heater disposed in an internal space of the film as the heat source 27c, and a pressurizing roller disposed to sandwich the film between the pressurizing roller and the heater as the pressurizing member 27b. As the heater, for example, a ceramic heater having a pattern of a heating element RH1 (FIG. 2) printed on a ceramic substrate, the heating element RH1 generating Joule heat when an electrical current is supplied thereto, is used. For example, a cylindrical fixing roller may be used as the heating member 27a. As the heat source 27c, for example, a halogen lamp that emits radiant heat when an electrical current is supplied thereto may be used.

The fixing device 27 includes a fixing-side connector 107, a relay board PCB1, and thermistors TH1 and TH2 (FIG. 2). These will be described below.

The motor 33 is a driving source that supplies a driving force for rotationally driving the rotary member in the image forming apparatus 1. In the present embodiment, the motor 33 can supply a driving force to, for example, the pressurizing roller of the fixing device 27, the photosensitive drum 19, and the rollers (12, 13, 15, 29, 31) that conveys the recording material S.

The power supply device 34 receives power from an AC power supply 10 (e.g., a commercial power supply) outside the image forming apparatus 1, and supplies the power to the units inside the image forming apparatus 1 including the heater of the fixing device 27, the control unit 35, and the motor 33. In addition, the power supply device 34 generates various high voltages (charging voltage, developing voltage, and transfer voltage) necessary for executing the electrophotographic process, and applies the generated high voltages to the charging roller 16, the developing roller 17, and the transfer roller 21.

The control unit 35 is a control circuit that controls the operation of the image forming apparatus 1. The control unit 35 includes a CPU 111 and a memory MM1 (FIG. 2). The memory MM1 includes volatile and non-volatile storage units. The memory MM1 stores a program for controlling an operation of the image forming apparatus 1, and holds various types of data used for controlling the image forming apparatus 1. The CPU 111 reads the program from the memory MM1 and executes the program, and controls the motor 33, the power supply device 34, and the like, thereby realizing various operations such as an image forming operation.

The cassette 11 is an accommodating portion in which the recording material S is loaded and accommodated. Each of the feed roller 12 (pickup roller), the conveyance roller pair 13, the registration roller pair 15, the conveyance roller pair 29, and the sheet discharge roller pair 31 is a conveyance member that conveys the recording material S. The sheet discharge tray 32 is a stacking portion on which the recording material S with an image formed thereon is stacked.

Note that, in the apparatus body 1A, sensors for the recording material are arranged along a conveyance path of the recording material S. A top sensor 14 is disposed between the conveyance roller pair 13 and the registration roller pair 15. A loop sensor 26 is disposed between the transfer nip and the fixing nip. A post-fixing sensor 28 is disposed between the fixing nip and the conveyance roller pair 29. The control unit 35 is connected to these sensors (14, 26, 28) to monitor the state of the recording material S based on a detection signal of the sensor, and manage the progress of the image forming operation.

### Image Forming Operation

A series of operations (an image forming operation and a printing operation) by which the image forming apparatus 1 forms an image on the recording material S while conveying the recording material S one sheet at a time will be described.

In the image forming operation, the recording material S loaded on the cassette 11 is fed one sheet at a time by the feed roller 12, conveyed by the conveyance roller pair 13, passed through the top sensor 14, and conveyed to the registration roller pair 15. The registration roller pair 15 conveys the recording material S to the transfer nip at a timing synchronized with the formation of the toner image in the process cartridge 20.

In the process cartridge 20, the photosensitive drum 19 is rotationally driven, and the charging roller 16 uniformly charges the surface of the photosensitive drum 19. The scanner unit 22 is driven by an image signal (video signal) generated based on image data, and irradiates the photosensitive drum 19 with laser light. As a result, the photosensitive drum 19 is exposed, and an electrostatic latent image is written on the surface of the photosensitive drum 19. The developing roller 17 carries toner and supplies the toner to the photosensitive drum 19 to develop the electrostatic latent image into a toner image. The toner image formed on the photosensitive drum 19 is transferred to the recording material S conveyed to the transfer nip by the transfer roller 21.

The recording material S having passed through the transfer nip is conveyed to the fixing device 27. The fixing device 27 fixes the toner image to the recording material S by heating and pressurizing the toner image on the recording material S while conveying the recording material S nipped between the heating member 27a and the pressurizing member 27b. The speed at which the recording material S is conveyed by the fixing device 27 is adjusted based on a detection signal of the loop sensor 26 such that the recording material S is not pulled between the transfer nip and the fixing nip. The recording material S discharged from the fixing device 27 is passed through the post-fixing sensor 28, conveyed by the conveyance roller pair 29, discharged to the outside of the apparatus body 1A by the sheet discharge roller pair 31, and stacked on the sheet discharge tray 32.

### Body Cable

FIG. 2 is a diagram illustrating an electric circuit including a body cable 100 (wiring member) according to the first embodiment. In the present embodiment, the fixing device 27 is electrically connected to the control unit 35 and the power supply device 34 via the body cable 100. The body cable 100 is a part of the apparatus body 1A. Note that the body cable 100 is not limited to being physically and electrically connected to the control unit 35 and the power supply device 34, and may be electrically connected to the control unit 35 and the power supply device 34 via another wiring member or a relay board.

The body cable 100 includes a body-side connector 102, an AC connector 105, a DC connector 101, an AC line HACL, an AC line HACN, a DC wire bundle 103, and a cutoff element 104 (fuse). The cutoff element 104 is a circuit breaker capable of cutting off conduction of some electric wires of the body cable 100.

The body-side connector 102 can be inserted into and removed from the fixing-side connector 107 provided in the fixing device 27. The body cable 100 is an example of a wiring member in which a first connector (body-side connector 102) is provided at an end, and the fixing-side connector 107 is an example of a second connector that can be inserted into and removed from the first connector. The body-side connector 102 of the present embodiment is a connector in which an AC connector portion 102A for AC voltage and a DC connector portion 102D for DC voltage or DC signal transmission are integrated.

One of the body-side connector 102 and the fixing-side connector 107 is a receptacle type (female type) connector, and the other of the body-side connector 102 and the fixing-side connector 107 is a plug type (male type) connector. In the present embodiment, a connector unit including the body-side connector 102 and the fixing-side connector 107 is a drawer connector Cn1. The drawer connector is a connector unit that includes, for example, a guide resin housing provided outside a contact member (terminal) and a floating mechanism that absorbs misalignment between connectors, enabling stable connection even when the connectors are frequently inserted/removed. The floating mechanism supports at least a part (a portion including the contact member) of the connector to be movable with respect to the frame body of the apparatus body 1A or the frame body of the fixing device 27. When the drawer connectors are connected to each other, first, the guide shapes of the resin housings are engaged with each other, and thereby, the contact members are aligned with each other by the floating mechanisms. Then, the contact members are brought into contact with each other to electrically connect the apparatus body 1A and the fixing device 27.

In the present embodiment, the drawer connector Cn1 is inserted (connected) at least when the fixing device 27 is mounted (attached) to the apparatus body 1A, and the drawer connector Cn1 is removed at least when the fixing device 27 is separated (detached) from the apparatus body 1A. In addition, as in a fourth embodiment to be described below, the drawer connector Cn1 may be inserted (connected) when the fixing device 27 moves from a use position to a retracted position, and the drawer connector Cn1 may be removed when the fixing device 27 moves from the retracted position to the use position.

The AC connector 105 is a connector for alternating current. The DC connector 101 is a connector for transmitting a DC voltage, a ground potential, and a DC signal. The AC connector 105 is connected to the AC connector 106 of the power supply device 34. The DC connector 101 is connected to a DC connector 108 of the control unit 35.

The AC line HACL and the AC line HACN are electric wires for alternating current. One ends of the AC line HACL and the AC line HACN are connected to the AC connector portion 102A of the body-side connector 102. The other ends of the AC line HACL and the AC line HACN are connected to the AC connector 105. The AC line HACL is electrically connected to one end of the heating element RH1 of the fixing device 27 via the body-side connector 102 and the fixing-side connector 107. The AC line HACN is electrically connected to the other end of the heating element RH1 of the fixing device 27 via the body-side connector 102 and the fixing-side connector 107. The AC line HACL and the AC line HACN are electric wires for supplying power to the heating element RH1 of the fixing device 27.

The DC wire bundle 103 is an electric wire for direct current. One end of the DC wire bundle 103 is connected to the DC connector portion 102D of the body-side connector 102. The other end of the DC wire bundle 103 is connected to the DC connector 101. The DC wire bundle 103 includes a plurality of wires. The DC wire bundle 103 of the present embodiment includes signal lines STH1, STH2, SIG, SIGR, LP, and LPR, and a ground line SGND.

The signal lines STH1 and STH2 and the ground line SGND are electrically connected to a connector of the relay board PCB1 via the body-side connector 102 and the fixing-side connector 107. The thermistor TH1 and the thermistor TH2 are connected to connectors of the relay board PCB1. In the relay board PCB1, the ground portions of the thermistor TH1 and the thermistor TH2 are combined into one. The one-combined ground portion is connected to the ground line SGND of the DC wire bundle 103. The thermistors TH1 and TH2 are temperature detection elements for detecting the temperature of the heating element RH1. Signals output from the thermistors TH1 and TH2 vary depending on the temperature of the heating element RH1. Based on the signals of the thermistors TH1 and TH2, the control unit 35 controls the power supply from the power supply device 34 to the heating element RH1 to maintain the fixing nip at a predetermined target temperature (fixing temperature) suitable for fixing an image.

The signal line LP is electrically connected to the signal line LPR via the body-side connector 102 and the fixing-side connector 107. Among a plurality of terminals of the fixing-side connector 107, terminals corresponding to the signal lines LP and LPR are short-circuited from each other by a short-circuit line 107S.

The signal line SIG is connected to one end of the cutoff element 104, and the signal line SIGR is connected to the other end of the cutoff element 104. The signal line SIGR is electrically connected to a connector of the relay board PCB1 via the body-side connector 102 and the fixing-side connector 107, and is further electrically connected to the ground line SGND of the DC wire bundle 103 through the relay board PCB1. The configuration of the cutoff element 104 will be described below.

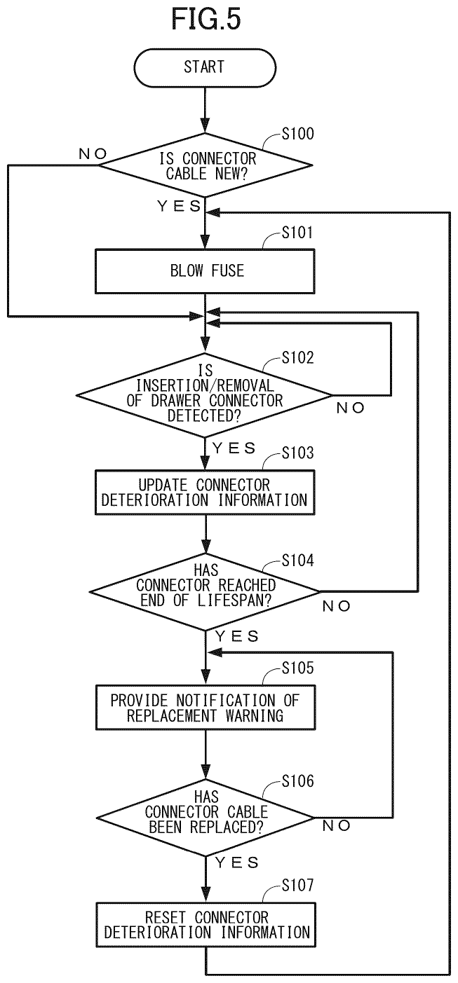

The control unit 35 is a control board on which a CPU 111, a memory MM1, a fusing circuit 110, an insertion/removal detection circuit 120, and the like are mounted. The memory MM1 stores information related to a deterioration of the body-side connector 102 (first connector) (connector deterioration information). In the present embodiment, a count value of the number of times of insertion/removal of the drawer connector Cn1 is stored in the memory MM1 as the connector deterioration information. Since the number of times of insertion/removal is reset when the body cable 100 is replaced (S107 in FIG. 5), the connector deterioration information of the present embodiment is the number of times the drawer connector Cn1 is inserted/removed after the cutoff element 104 (fuse) of the body cable 100 is fused. The fusing circuit 110 and the insertion/removal detection circuit 120 will be described below.

Note that the number of times of insertion and removal of the drawer connector Cn1 may be based on any of the number of times the drawer connector Cn1 is inserted, the number of times the drawer connector Cn1 is removed, and the number of times a set of insertion and removal of the drawer connector Cn1 is performed. In the embodiment of the present embodiment, the number of times the drawer connector Cn1 is inserted is regarded as the number of times of insertion/removal (see S102 in FIG. 5).

In the present embodiment, when the fixing device 27 is attached to and detached from the apparatus body 1A, the fixing-side connector 107 of the fixing device 27 and the body-side connector 102 of the apparatus body 1A are inserted/removed. That is, when the fixing device 27 is attached to the apparatus body 1A, the fixing-side connector 107 and the body-side connector 102 are inserted (connected). Further, when the fixing device 27 is separated (detached) from the apparatus body 1A, the fixing-side connector 107 and the body-side connector 102 are removed (disconnected).

Each of the fixing-side connector 107 and the body-side connector 102 has an AC contact through which an alternating current supplied from the power supply device 34 flows to the heating element RH1 and a DC contact through which a DC voltage or signal passes.

### AC Contact

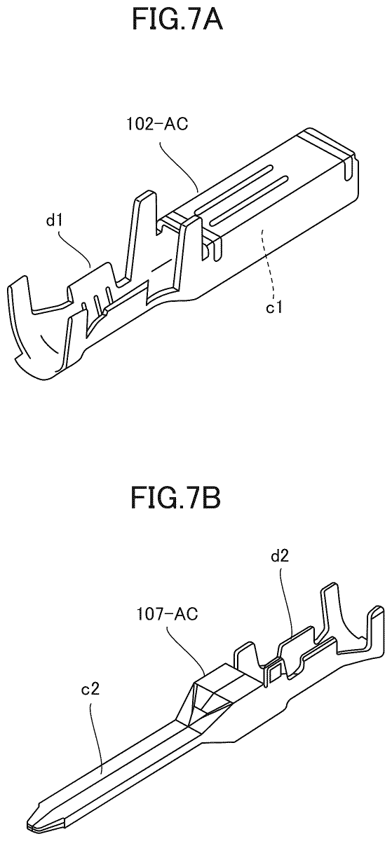

An example of an AC contact is illustrated in FIGS. 7A and 7B. The fixing-side connector 107 has a tab contact 107-AC as an AC contact. The body-side connector 102 has a receptacle contact 102-AC (receptacle contact) as an AC contact. The tab contact 107-AC and the receptacle contact 102-AC are members obtained by plating a copper alloy with nickel or tin. Nickel plating may be used as base plating, and gold plating may be applied thereon. In addition, the tab contact 107-AC and the receptacle contact 102-AC have a shape for crimping and holding an AC line in addition to the contact shape for engaging the counterpart.

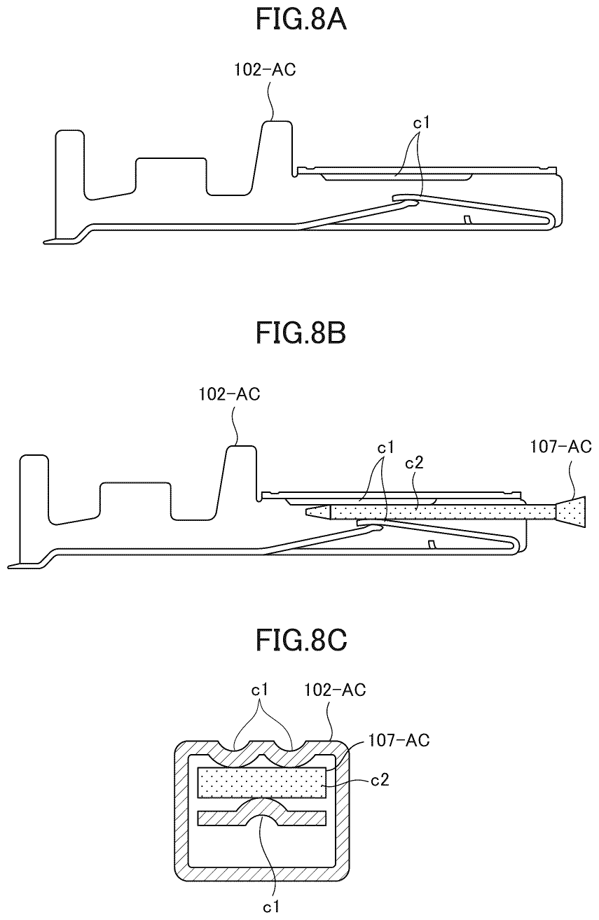

The tab contact 107-AC includes a contact portion c2 formed in a flat plate shape, and a connection portion d2 connected to an end portion of an electric wire in the fixing device 27 in a crimping manner or the like. The contact portion c2 may have, for example, a rod shape. The receptacle contact 102-AC includes a contact portion c1 in contact with the flat plate-shaped contact portion c2 of the tab contact 107-AC, and a connection portion d1 connected to the ends of the AC line HACL and the AC line HACN in a crimping manner or the like (see FIG. 8B).

FIG. 8A illustrates an internal structure of the receptacle contact 102-AC. FIG. 8B illustrates a state in which the contact portion c2 of the tab contact 107-AC is inserted into the receptacle contact 102-AC. FIG. 8C is a cross-sectional view of the tab contact 107-AC and the receptacle contact 102-AC at a location where the contact portions c1 and c2 contact each other. As illustrated in FIGS. 8B and 8C, the contact c1 has a shape having elasticity (spring property), and is configured to pressure contact the contact portion c2 at a plurality of positions to sandwich and hold the flat plate-shaped contact portion c2. As a result, stable conduction is realized.

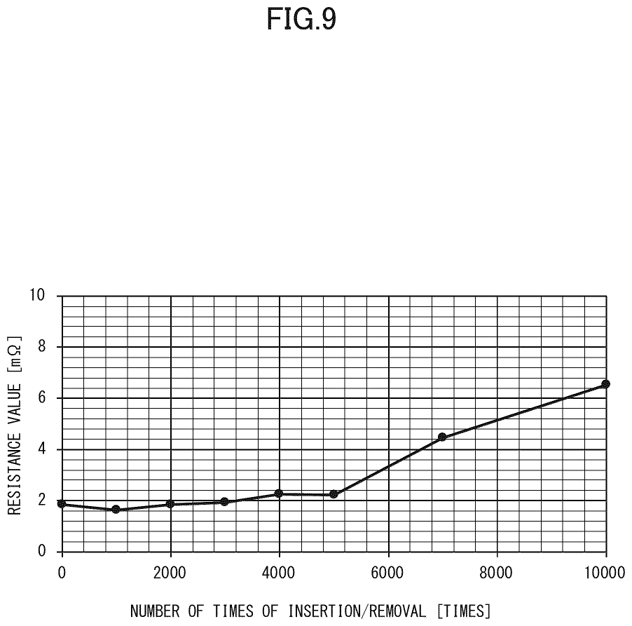

FIG. 9 illustrates a result of an example in which a change in resistance at the AC contact is confirmed in a case where the fixing-side connector 107 and the body-side connector 102 are repeatedly inserted/removed. The tab contact 107-AC and the receptacle contact 102-AC used in the experiment have contact portions c1 and c2 in which nickel base plating is applied on a copper alloy and gold plating is applied thereon. That is, the tab contact 107-AC and the receptacle contact 102-AC used in the experiment have relatively high durability against insertion/removal.

As illustrated in FIG. 9, a change in resistance value was not particularly observed up to about 5000 times of insertion/removal, but an increase in resistance value was observed when the number of times of insertion/removal exceeded 5000 times. The reason why the resistance value increased was that the contact portions c1 and c2 were scratched or the plating was worn or peeled due to the insertion/removal.

The AC contact including the tab contact 107-AC and the receptacle contact 102-AC is a path for supplying power to the heating element RH1 of the fixing device 27, and a relatively large current flows in the AC contact. When the resistance value of the AC contact increases, an energy loss at the contact portions c1 and c2 and a rise in temperature of the wiring may occur due to Joule heat. In addition, the scratches on the contact portions c1 and c2 or the wear or peeling of the plating may increase a friction coefficient between the contact portions c1 and c2, requiring a larger force for inserting/removing the connectors, which may reduce workability.

Not limited to the example described above, there was a need for a new configuration capable of detecting the state of the connector (replacement with a new one or degree of deterioration) in a configuration in which an apparatus body-side connector and a unit-side connector attached to the apparatus body are connected and disconnected.

Therefore, in the present embodiment, by arranging the cutoff element 104 to be described below in the body cable 100, the number of times of insertion/removal of the drawer connector Cn1 is counted, making it possible to replace a component when insertion and removal is performed in an appropriate number of times. In particular, in the present embodiment, in a configuration in which the body-side connector 102 may deteriorate by repeatedly attaching and detaching the fixing device 27, the body-side connector 102 and the body cable 100 can be replaced in an appropriate number of times.

### Cutoff Element

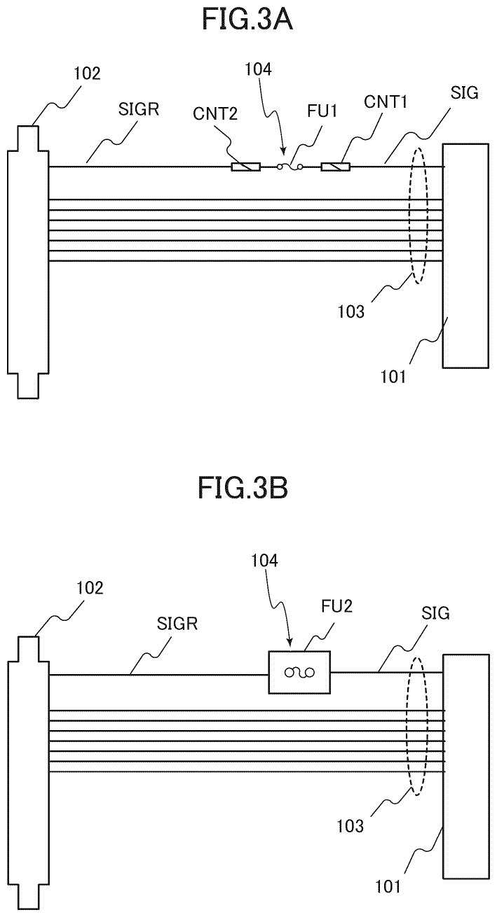

FIG. 3A is a schematic diagram illustrating a configuration of a cutoff element 104 according to an example of the present embodiment. The cutoff element 104 of the present example is formed of a lead-type fuse FU1. One end of the lead-type fuse FU1 is connected to a signal line SIG by a crimping terminal CNT1, and the other end of the lead-type fuse FU1 is connected to a signal line SIGR by a crimping terminal CNT2. The cutoff element 104 cuts off electrical connection between the signal line SIG and the signal line SIGR when an electrical current flows therethrough to blow the lead-type fuse FU1.

FIG. 3B is a schematic diagram illustrating a configuration of a cutoff element 104 according to another example of the present embodiment. The cutoff element 104 includes a chip-type fuse FU2. The signal line SIG and the signal line SIGR are connected to connectors of the chip-type fuse FU2. The cutoff element 104 cuts offs electrical connection between the signal line SIG and the signal line SIGR when an electrical current flows therethrough to blow a fusible body on the chip of the chip-type fuse FU2.

The lead-type fuse FU1 and the chip-type fuse FU2 may be fuse resistors that normally function as normal resistance elements (allowing a current less than the rated current to flow) and are blown when a current equal to or more than the rated current flows.

As described above, in the body cable 100, the cutoff element 104 of the present embodiment is disposed in the middle of the wiring (SIG, SIGR) connecting the terminal of the body-side connector 102 (first connector) and the terminal of the DC connector 101 (third connector) on the control unit 35 side.

### Fusing Circuit

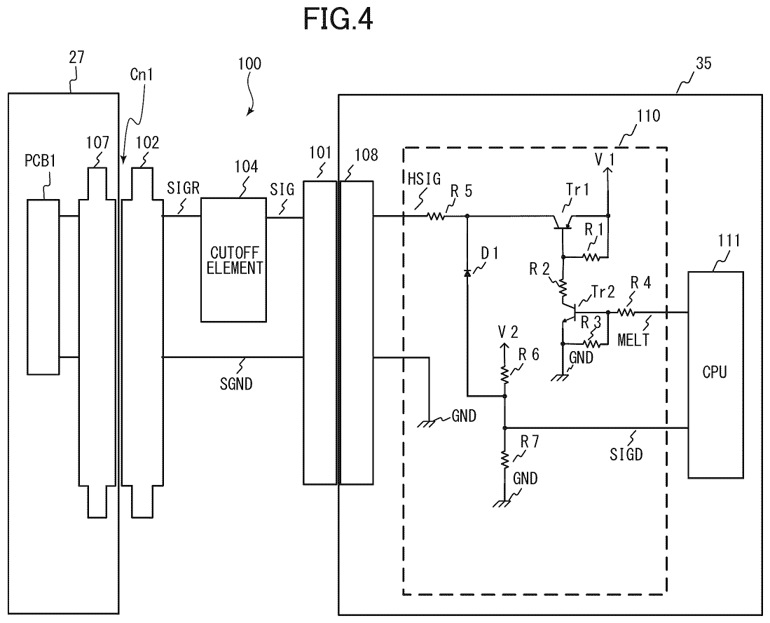

FIG. 4 is a diagram illustrating a configuration of the fusing circuit 110. A signal line (MELT signal) of the CPU 111 is connected to one end of a resistor R4. The other end of the resistor R4 is connected to a base terminal of a transistor Tr2. A resistor R3 is connected between the base terminal and an emitter terminal of the transistor Tr2. The emitter terminal of the transistor Tr2 and the resistor R3 are connected to a ground GND.

One end of a resistor R2 is connected to a collector terminal of the transistor Tr2, and the other end of the resistor R2 is connected to a base terminal of a transistor Tr1. A resistor R1 is connected between the base terminal and an emitter terminal of the transistor Tr1. One end of the resistor R1 and the emitter terminal of the transistor Tr1 are connected to a power supply V1. The power supply V1 is a DC power supply, and supplies a voltage of 24 V in the present embodiment. A collector terminal of the transistor Tr1 is connected to a cathode terminal of a diode D1 and one end of a resistor R5. The other end of the resistor R5 is connected to a signal line HSIG.

An anode terminal of the diode D1 is connected to one end of a resistor R6, one end of a resistor R7, and one end of a signal line SIGD. The other end of the resistor R6 is connected to a power supply V2. The power supply V2 is a DC power supply, and supplies a voltage of 3.3 V in the present embodiment. The other end of the resistor R7 is connected to a ground GND. The voltage of the power supply V2 is divided by the resistors R6 and R7, and the divided voltage is input to the CPU 111 by the signal line SIGD. The other end of the signal line HSIG is connected to the DC connector 108, and is electrically connected to a signal line SIG of the DC connector 101. The ground line SGND is electrically connected to the ground GND in the control unit 35 via the DC connector 101 and the DC connector 108.

Next, the operation of the fusing circuit 110 will be described. When the CPU 111 outputs a high-level MELT signal, the transistors Tr2 and Tr1 are turned on, and a current flows through the signal line HSIG. In addition, a current flows through a circuit including the signal lines SIG and SIGR and cutoff element 104 of the body cable 100, the relay board PCB1 of the fixing device 27, and the ground line SGND of the body cable 100. A value of the current flowing through the signal line SIG, etc. in response to the high-level MELT signal is larger than a rated current of the cutoff element 104. Accordingly, the cutoff element 104 is fused (the fuse is blown). That is, the cutoff element 104 (fuse) is configured to be fused in accordance with a command from the control unit 35.

Next, detection of fusing by the CPU 111 will be described. The CPU 111 reads an input signal (SIGD signal) from the signal line SIGD in a state where the MELT signal is at a low level. When the cutoff element 104 is not fused, a low-level SIGD signal is input to the CPU 111. The low-level SIGD signal is a voltage value obtained by dividing the voltage of the power supply V2 by the resistor R6 and the combined resistor of the resistor R5 and the resistor R7. The resistance values of the resistors R5, R6, and R7 are set such that the low-level SIGD signal is, for example, 0.5 V or less. The low-level signal should be designed to match the input low voltage (Vil) of the CPU 111, and is not limited thereto.

On the other hand, when the cutoff element 104 is not fused, a high-level SIGD signal is input to the CPU 111. The high-level SIGD signal is a voltage value obtained by dividing the voltage of the power supply V2 by the resistors R6 and R7. The resistance values of the resistors R6 and R7 are set such that the high-level signal is, for example, 2.4 V or more. The high-level SIGD signal should be designed to match the input high voltage (Vih) of the CPU 111, and is not limited thereto.

As described above, the fusing circuit 110 functions as a detection circuit that depends on whether the cutoff element 104 (fuse) is in a fused state or not (i.e., blown or not). The CPU 111 can detect whether the cutoff element 104 is in a fused state (whether the fuse is blown) based on an input signal (SIGD signal) from the fusing circuit 110. In addition, the CPU 111 can cause the cutoff element 104 to be fused or blown via the fusing circuit 110.

### Insertion/Removal Detection Circuit

Next, the insertion/removal detection circuit 120 will be described with reference to FIG. 2. The insertion/removal detection circuit 120 of the present embodiment is an insertion/removal detection unit for detecting insertion/removal of the drawer connector Cn1 including the body-side connector 102 and the fixing-side connector 107.

The insertion/removal detection circuit 120 includes an input terminal LPIN of the CPU 111, a resistor R10 (pull-up resistor), a resistor R20, and a ground GND. The input terminal LPIN of the CPU 111 is connected to one end of the resistor R10 and one end of the resistor R20. The other end of the resistor R10 is connected to a 3.3 V DC power supply. The other end of the resistor R20 is electrically connected to the signal line LP of the body cable 100 via the DC connectors 101 and 108. The ground GND is electrically connected to the signal line LPR of the body cable 100 via the DC connectors 101 and 108.

In addition, the short-circuit line 107S that short-circuits the signal line LP and the signal line LPR is provided in the fixing device 27. The short-circuit line 107S functions as a switch that opens and closes the insertion/removal detection circuit 120. That is, when the body-side connector 102 and the fixing-side connector 107 are connected, the insertion/removal detection circuit 120 is closed, and a low-level voltage is input to the input terminal LPIN of the CPU 111. When the body-side connector 102 and the fixing-side connector 107 are disconnected, the insertion/removal detection circuit 120 is opened, and a high-level voltage is input to the input terminal LPIN of the CPU 111.

As described above, the CPU 111 can detect whether the drawer connector Cn1 is in an inserted state (connected state) or a removed state (disconnected state) based on the input signal from the insertion/removal detection circuit 120. In addition, the CPU 111 can detect an insertion event and a removal event of the drawer connector Cn1 based on a change in the input signal from the insertion/removal detection circuit 120.

In the present embodiment, the insertion/removal detection circuit 120 serving as an insertion/removal detection unit for detecting insertion/removal of the drawer connector Cn1 is arranged in the apparatus body 1A, but a circuit having a function similar to that of the insertion/removal detection circuit 120 may be arranged in the fixing device 27.

### Control Method

Next, a control method of the image forming apparatus 1 will be described. FIG. 5 is a flowchart illustrating an example of control in the present embodiment. Each step of the flowchart is realized by the CPU 111 reading the program from the memory MM1 and executing the program.

The CPU 111 starts execution of this flow when the control unit 35 is activated by supplying power from the power supply device 34. That is, this flow is continuously processed while the main power supply of the image forming apparatus 1 is turned on.

In S100, the CPU 111 reads an input signal (SIGD signal) from the fusing circuit 110 with a low-level MELT signal, and detects whether the body cable 100 is new. When the input signal from the fusing circuit 110 indicates that the cutoff element 104 is not fused (when the SIGD signal is at a low level), the CPU 111 determines that the body cable 100 is new, and proceeds to S101. In S101, the CPU 111 outputs a high-level MELT signal to fuse the cutoff element 104. After fusing the cutoff element 104, the CPU 111 determines that the body cable 100 is not new (old), and proceeds to S102. On the other hand, when the input signal from the fusing circuit 110 indicates that the cutoff element 104 has been fused in S100 (when the SIGD signal is at a high level), the CPU 111 determines that the body cable 100 is not new, and proceeds to S102.

Note that, in the present embodiment, the cutoff element 104 is fused immediately after it is determined that the body cable 100 is new, but the cutoff element 104 may be fused when the body-side connector 102 and the fixing-side connector 107 are inserted/removed a predetermined number of times after it is determined that the body cable 100 is new. This makes it possible to operate the apparatus without fusing the cutoff element, for example, as a temporary operation in a stage where the body cable 100 is assembled during manufacturing or in a stage where the body cable 100 is replaced after being installed in a user environment.

In S102, the CPU 111 monitors insertion/removal of the drawer connector Cn1 based on the input signal (LPIN signal) from the insertion/removal detection circuit 120. When the LPIN signal changes from a low level to a high level, the CPU 111 determines that the drawer connector Cn1 has been inserted/removed, and proceeds to S103. The CPU 111 may be determined that the drawer connector Cn1 is inserted/removed, when the LPIN signal changes from the high level to the low level.

In S103, the CPU 111 updates the connector deterioration information. That is, the CPU 111 adds 1 to the count value of the number of times of insertion/removal of the drawer connector Cn1 stored in the memory MM1, stores the number of times of insertion/removal after the addition in the memory MM1, and proceeds to S104.

In S104, the CPU 111 determines whether the body-side connector 102 has reached its end of lifespan. Specifically, the CPU 111 determines whether the count value of the number of times of insertion/removal of the drawer connector Cn1 stored in the MM1 exceeds a predetermined number of times A. The predetermined number of times A is set in advance as an upper limit of the number of times of insertion/removal of the body-side connector 102. In the first embodiment, the predetermined number of times A is set to, for example, 5000 times. The predetermined number of times A may be other than 5000 times. When the number of times of insertion/removal is less than the predetermined number of times A, the process returns to S102, and when the number of times of insertion/removal is equal to or greater than the predetermined number of times A, the process proceeds to S105.

In S105, the CPU 111 notifies a user or the like of information (replacement warning) urging the user or the like to replace the body cable 100. The content of the notification may be, for example, “it is necessary to replace the body cable 100 because there is a possibility that a contact failure occurs as the connector has deteriorated”. The notification method may be a message displayed on an operation panel (liquid crystal panel) serving as an operation unit included in the image forming apparatus 1, a voice notification, or a pop-up screen displayed on an external computer connected to the image forming apparatus 1. The notification target may be a user or a service person in charge of maintenance of the image forming apparatus 1.

In S106, the CPU 111 reads an input signal (SIGD signal) from the fusing circuit 110 in a state where a MELT signal is at a low level, and determines whether the body cable 100 has been replaced. When the SIGD signal is at a low level, the CPU 111 determines that the body cable 100 has been replaced with a new one, and proceeds to S107. On the other hand, when the SIGD signal is at a high level in S106, the CPU 111 determines that the body cable 100 has not been replaced and stands by. Note that, when it is not detected that the body cable 100 has been replaced in S106, the process may return to S102, allowing insertion/removal of the drawer connector Cn1 even though notification of the replacement warning is provided.

In S107, the CPU 111 resets the number of times of insertion/removal of the drawer connector Cn1 stored in the memory MM1, and returns to S101.

### Summary of First Embodiment

As described above, in the first embodiment, the cutoff element 104 (fuse) is provided in the body cable 100 of the apparatus body 1A. As a result, it is possible to detect whether the body cable 100 is new depending on whether the cutoff element 104 is fused. In addition, it is possible to detect a degree of deterioration of the body-side connector 102 based on the number of times of insertion and removal of the connector after the cutoff element 104 is fused, and provide notification of a replacement warning, for example, by determining that the body cable 100 has reached its end of lifespan.

That is, according to the present embodiment, it is possible to provide an image forming apparatus of a new form having a configuration capable of detecting a state of a connector.

### Second Embodiment

A second embodiment will be described. The second embodiment is different from the first embodiment in the details of the cutoff element (fuse) in the wiring member. Hereinafter, elements denoted by reference numerals common to those of the first embodiment are assumed to have basically the same configurations and operations as those described in the first embodiment unless otherwise specified, and portions different from those of the first embodiment will be mainly described.

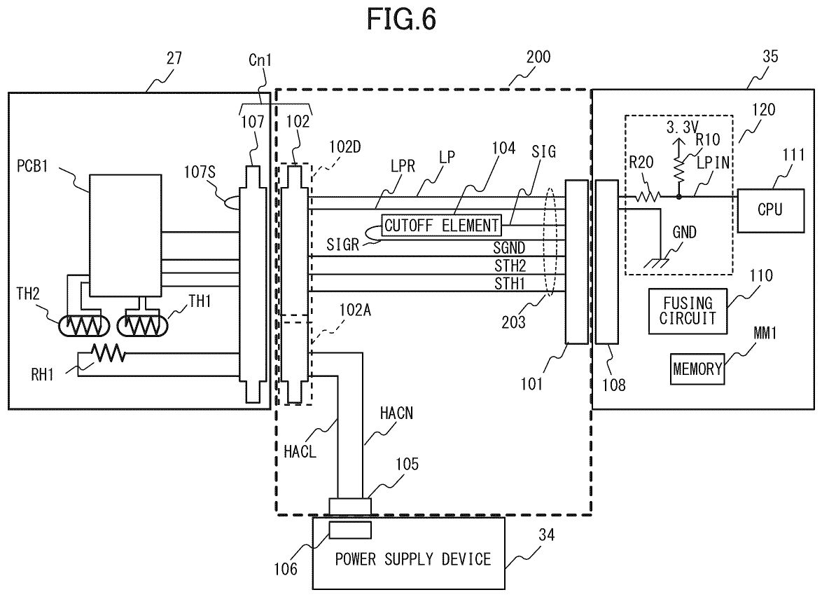

FIG. 6 is a diagram illustrating an electric circuit including a body cable 200 (wiring member) according to the second embodiment. As in the first embodiment, the fixing device 27 is electrically connected to the control unit 35 and the power supply device 34 via the body cable 200. The body cable 200 is a part of the apparatus body 1A.

The body cable 200 includes a body-side connector 102, an AC connector 105, a DC connector 101, an AC line HACL, an AC line HACN, a DC wire bundle 203, and a cutoff element 104 (fuse). The DC wire bundle 203 includes signal lines STH1, STH2, SIG, SIGR, LP, and LPR, and a ground line SGND.

In the present embodiment, as compared with the first embodiment, the signal line SIGR connected to the other end of the cutoff element 104 (a terminal opposite to the terminal connected to the signal line SIG) is connected to the DC connector 101 rather than the body-side connector 102. The signal line SIGR is electrically connected to the ground GND in the control unit 35 via the DC connector 101 and the DC connector 108 of the control unit 35.

In some case, the number of terminals in the AC connector portion 102A and the DC connector portion 102D of the body-side connector 102 may be determined. Therefore, when the number of terminals in the AC connector portion 102A or the DC connector portion 102D increases to add a wiring structure including the cutoff element 104, the outer shape of the body-side connector 102 may increase, and the size of the fixing device 27 may also increase.

According to the present embodiment, the cutoff element 104 is disposed in a looped wiring or loop-shaped wiring structure (SIG, SIGR) that connects the terminals of the DC connector 101 (third connector) to each other. Therefore, it is not necessary to increase the number of terminals of the AC connector portion 102A or the DC connector portion 102D to dispose the cutoff element 104. Therefore, it is possible to suppress an increase in size of the body-side connector 102 and to contribute to a reduction in size of the fixing device 27.

The contents of the control performed by the control unit 35 with respect to the cutoff element 104 are the same as those in the first embodiment. That is, the CPU 111 of the control unit 35 can detect whether the cutoff element 104 is in a fused state (whether the fuse is blown) based on an input signal (SIGD signal) from the fusing circuit 110. In addition, the CPU 111 can cause the cutoff element 104 to be fused or blown with the fusing circuit 110. Then, for example, according to the flow described with reference to FIG. 5, it is possible to detect whether the body cable 200 is new based on whether the cutoff element 104 is fused, and to urge that the body cable 200 be replaced at an appropriate time.

According to the present embodiment, it is possible to provide an image forming apparatus of a new form having a configuration capable of detecting a state of a connector.

### Third Embodiment

As a third embodiment, a configuration in which a storage unit that stores information (deterioration information) related to a deterioration of a unit-side connector is arranged in a unit attached to an apparatus body will be described. Hereinafter, elements denoted by reference numerals common to those of the first embodiment are assumed to have basically the same configurations and operations as those described in the first embodiment unless otherwise specified, and portions different from those of the first embodiment will be mainly described.

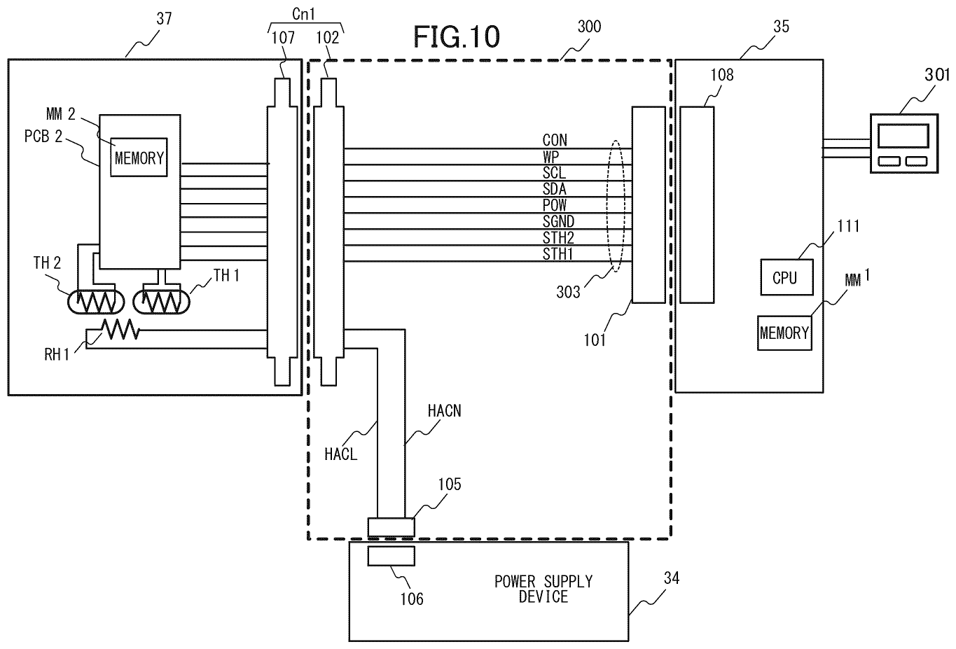

FIG. 10 is a diagram illustrating an electric circuit including a body cable 300 according to the third embodiment. In the present embodiment, a fixing device 37 is electrically connected to the control unit 35 and the power supply device 34 via the body cable 300. The body cable 300 is a part of the apparatus body 1A.

The fixing device 37 includes a fixing-side connector 107, a relay board PCB2, thermistors TH1 and TH2, and a heating element RH1. A memory MM2 is mounted on the relay board PCB2 (memory board). The memory MM2 is a storage unit that stores information (connector deterioration information) related to a deterioration of the fixing-side connector 107 that is a unit-side connector (second connector). In a state where the fixing device 37 is attached to the apparatus body 1A, the memory MM2 is electrically connected to the control unit 35 via the fixing-side connector 107 and the body-side connector 102. In addition to the connector deterioration information, information related to the fixing device 37 such as a serial number of the fixing device 37 may be stored in the memory MM2.

On the other hand, the memory MM1 in the control unit 35 stores information (connector deterioration information) related to a deterioration of the body-side connector 102 that is a first connector. In a case where the memory MM2 in the fixing device 37 is a first storage unit, the memory MM1 in the apparatus body 1A is a second storage unit.

In the present embodiment, the number of times of insertion/removal of the connector is used as the connector deterioration information to be stored in the memories MM1 and MM2. The connector deterioration information (the number of times of insertion/removal of the body-side connector 102) stored in the memory MM1 of the apparatus body 1A does not necessarily match the connector deterioration information (the number of times of insertion/removal of the fixing-side connector 107) stored in the memory MM2 of the fixing device 37. This is because, when the fixing device 37 is replaced or the body cable 300 is replaced, only one of the number of times of insertion/removal of the body-side connector 102 and the number of times of insertion/removal of the fixing-side connector 107 is reset.

The body cable 300 includes a body-side connector 102, a DC connector 101, a DC wire bundle 303, an AC connector 105, an AC line HACL, and an AC line HACN. The DC wire bundle 303 includes signal lines STH1, STH2, SDA, SCL, WP, and CON, a power supply line POW, and a ground line SGND. In comparison with the first embodiment, the power supply line POW, and the signal lines SDA, SCL, WP, and CON are added.

The power supply line POW, the signal lines SDA, SCL, WP, and CON, and the ground line SGND are electrically connected to a connector of the relay board PCB2 of the fixing device 37 via the body-side connector 102 and the fixing-side connector 107. The power supply line POW and the ground line SGND are used to supply power to the memory MM2. In the relay board PCB2, the ground portions of the thermistors TH1 and TH2 and the ground portion of the memory MM2 are combined into one. The one-combined ground portion is electrically connected with the ground line SGND of the DC wire bundle 303.

In the present embodiment, an EEPROM corresponding to inter-integrated circuit (I2C) communication is used as an example of the memory MM2. The signal line SDA is for a serial data signal of I2C communication. The signal line SCL is for a serial clock signal of I2C communication. The signal line WP is for a write protect signal of the memory MM2, and is used for a write instruction. The signal line CON is used to detect insertion/removal of the drawer connector Cn1.

The image forming apparatus 1 includes an operation panel 301 as a user interface (operation display unit). The operation panel 301 is communicably connected to the control unit 35. The operation panel 301 includes, for example, a liquid crystal panel (display unit) and an operation switch. The operation panel 301 displays a message on the liquid crystal panel based on a signal from the control unit 35, receives an input (an operation of an operation switch or the like) from a user who has viewed the message, and transmits the input to the control unit 35.

In the present embodiment, unlike the first embodiment and the second embodiment, a cutoff element is not provided in the body cable 300 of the apparatus body 1A. In addition, the control unit 35 does not have a fusing circuit for the cutoff element. However, in the present embodiment, the configuration related to the cutoff element 104 described in the first embodiment or the second embodiment may be used in combination.

In the present embodiment, a user or a service person operates the operation panel 301 to input completion of replacement when the body cable 300 has been replaced, instead of detecting a new body cable 300 or providing notification of a time to replace the body cable 300 using the cutoff element and the fusing circuit. The control unit 35 detects that the body cable 300 has been replaced based on the input information acquired from the operation panel 301. In the present embodiment, since the cutoff element and the fusing circuit can be omitted, the configuration of the image forming apparatus 1 can be simplified.

### Control Method

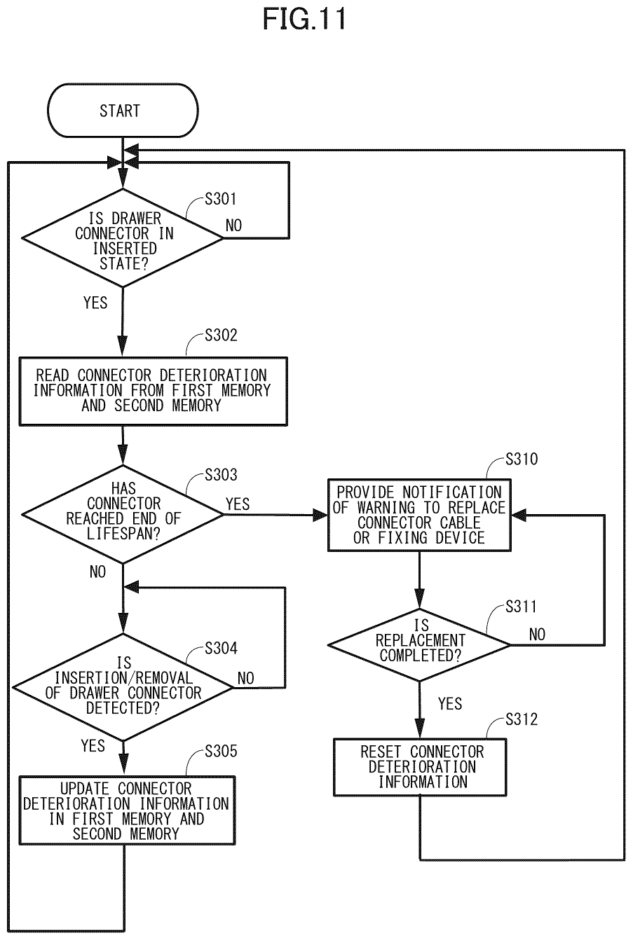

FIG. 11 is a flowchart illustrating an example of control in the present embodiment. Each step of the flowchart is realized by the CPU 111 reading the program from the memory MM1 and executing the program.

The CPU 111 starts execution of this flow when the control unit 35 is activated by supplying power from the power supply device 34. That is, this flow is continuously processed while the main power supply of the image forming apparatus 1 is turned on.

In S301, the CPU 111 detects whether the drawer connector Cn1 is inserted. Insertion/removal of the drawer connector Cn1 using the signal line CON is detected as follows. A 3.3 V power supply in the control unit 35 is connected to the relay board PCB2 of the fixing device 37 via the power supply line POW, and is further connected to the signal line CON via a circuit in the relay board PCB2. The signal line CON is electrically connected to a port of the CPU 111 through the DC connectors 101 and 108 and a circuit in the control unit 35.

Therefore, when the drawer connector Cn1 is inserted, a high-level signal (CON signal) is input to the port of the CPU 111 via the signal line CON. When the drawer connector Cn1 is removed, the CON signal becomes a low level. The CPU 111 detects that the drawer connector Cn1 is inserted based on a change of the CON signal from the low level to the high level.

In S302, the CPU 111 reads the connector deterioration information of the body-side connector 102 stored in the memory MM1 of the apparatus body 1A and the connector deterioration information of the fixing-side connector 107 stored in the memory MM2 of the fixing device 37. In the present embodiment, a count value of the number of insertion/removal of the fixing-side connector 107 or the body-side connector 102 is used as the connector deterioration information.

In S303, the CPU 111 determines whether the read connector deterioration information has reached a predetermined value (a value indicating the lifespan of the connector, hereinafter referred to as a lifespan value). In the present embodiment, a count value of 5000 times that is the number of times of insertion/removal is set as the lifespan value. The lifespan value for the connector deterioration information of the body-side connector 102 and the lifespan value for the connector deterioration information of the fixing-side connector 107 are not necessarily the same value, but both are set to 5000 times in the present embodiment.

When the connector deterioration information is equal to or more than the lifespan value in S303, the CPU 111 determines that the body-side connector 102 or the fixing-side connector 107 needs to be replaced, and the process proceeds to S310. In S310, the CPU 111 notifies a user or the like of information urging the user or the like to replace the body cable 100 or information urging the user or the like to replace the fixing device 37 (hereinafter, collectively referred to as a replacement warning). When the connector deterioration information of the body-side connector 102 reaches the lifespan value, notification of a warning to replace the body cable 100 (wiring member) is provided. When the connector deterioration information of the fixing-side connector 107 reaches the lifespan value, notification of a warning to replace the fixing device 37 is provided. In other words, the control unit 35 provides notification of information urging replacement the unit (fixing device 37) detachable from apparatus body 1A based on the information related to the degree of deterioration of the second connector (fixing-side connector 107).

As an example of a method of providing notification of a replacement warning, in the present embodiment, a message urging replacement of the body cable 300 or the fixing device 37 is displayed on the operation panel 301. The notification method is not limited thereto, and may be a voice notification through a speaker included in the image forming apparatus 1, or may be a pop-up screen displayed on an external computer connected to the image forming apparatus 1. The content of the notification may be, for example, “it is necessary to replace the body cable 100 or the fixing device 37 because there is a possibility that a contact failure occurs as the connector has deteriorated”. The notification target may be a user or a service person in charge of maintenance of the image forming apparatus 1.

Upon receiving the replacement warning, the user or the service person replaces the body cable 300 or the fixing device 37. When the replacement work is completed and it is detected that the completion of the replacement is input on the operation panel 301, the CPU 111 resets the connector deterioration information in S312. That is, when the body cable 100 is replaced, the connector deterioration information of the body-side connector 102 stored in the memory MM1 is reset (the number of times of insertion/removal is set to 0). When the fixing device 37 is replaced, the connector deterioration information of the fixing-side connector 107 stored in the memory MM2 is reset (the number of times of insertion/removal is set to 0). On the other hand, when the connector deterioration information is less than the lifespan value in S303, the CPU 111 determines that the body-side connector 102 or the fixing-side connector 107 does not need to be replaced, and the process proceeds to S304. In S304, the CPU 111 stands by until insertion/removal of the drawer connector Cn1 is detected. The CPU 111 detects insertion/removal of the drawer connector Cn1 based on a change of the CON signal from the low level to the high level.

When insertion/removal of the drawer connector Cn1 is detected in S304, the CPU 111 updates the connector deterioration information of the body-side connector 102 and the fixing-side connector 107 in S305. That is, the CPU 111 stores a value obtained by adding 1 to the connector deterioration information (the number of times of insertion/removal) of the body-side connector 102 stored in the memory MM1 of the apparatus body 1A as new connector deterioration information in the memory MM1. In addition, the CPU 111 stores a value obtained by adding 1 to the connector deterioration information (the number of times of insertion/removal) of the fixing-side connector 107 stored in the memory MM2 of the fixing device 37 as new connector deterioration information in the memory MM2. After updating the connector deterioration information, the CPU 111 returns to S301.

### Summary of Third Embodiment

In the third embodiment, the memory MM2 that stores the connector deterioration information of the fixing-side connector 107 is provided in the fixing device 37, which is a unit detachable from the apparatus body 1A. As a result, for example, even when the fixing device 37 detached from one apparatus body 1A is attached to another apparatus body 1A, the control unit 35 of the image forming apparatus 1 can correctly grasp the degree of deterioration of the fixing-side connector 107.

That is, according to the present embodiment, it is possible to provide an image forming apparatus of a new form having a configuration capable of detecting a state of a connector.

### Modification

In the present embodiment, the count value of the number of times of insertion/removal of the drawer connector Cn1 is used as it is as the connector deterioration information, but for example, a count-up value obtained by multiplying the number of times of insertion/removal by a coefficient may be used as the connector deterioration information. For example, in a state where the number of times of insertion/removal is still small, deterioration (scratches, peeling of plating, and the like) in the contact portions c1 and c2 is small, and thus a degree of progress of deterioration in the contact portions per one time of insertion/removal is relatively small. On the other hand, in a state where the number of times of insertion/removal has already been large, deterioration in the contact portions c1 and c2 is large, and thus a degree of progress of deterioration in the contact portions per one time of insertion/removal may be relatively large. Therefore, for example, when the number of times of insertion/removal is small, the increment of the count value per one time of insertion/removal may be set to “1”, and when the number of times of insertion/removal is large, the increment of the count value per one time of insertion/removal may be set to a value (e.g., “2”) larger than 1.

By switch the increment of the count value described above to a discontinuous (stepwise) increment of a count value, the increment of the count value per one time of insertion/removal may continuously increase according to the number of times of insertion/removal.

The connector deterioration information is not limited to an amount based on the number of times of insertion/removal of the drawer connector Cn1. For example, a circuit for monitoring a change in resistance (see FIG. 9) of the AC contact in the drawer connector Cn1 may be added, and a current resistance value of the AC contact may be used as the connector deterioration information.

In the present embodiment, an example has been described in which the lifespan value corresponding to each of the connector deterioration information of the body-side connector 102 and the connector deterioration information of the fixing-side connector 107 is set. Alternatively, a lifespan value may be set for a total value of the connector deterioration information of the body-side connector 102 and the connector deterioration information of the fixing-side connector 107, and notification of a warning to replace the fixing device 37 and the body cable 300 may be provided when the total value becomes equal to or larger than the lifespan value.

In addition, the insertion/removal of the drawer connector Cn1 may be detected, for example, depending on whether the control unit 35 can read information (serial number or the like) stored in the memory MM2, instead of the insertion/removal detection circuit 120 described in the present embodiment. In this case, the signal line CON is unnecessary, and the number of pins of the drawer connector Cn1 (the number of pins of the DC connector portion 102D) can be reduced as compared with that in the present embodiment. In addition, the insertion/removal detection circuit 120 described in the first embodiment may be used as an insertion/removal detection unit that detects insertion/removal of the drawer connector Cn1.

### Fourth Embodiment

As a fourth embodiment, a configuration in which the fixing device is movable with respect to the apparatus body of the image forming apparatus and the connector is inserted/removed when the fixing device moves will be described. Hereinafter, elements denoted by reference numerals common to those of the first embodiment are assumed to have basically the same configurations and operations as those described in the first embodiment unless otherwise specified, and portions different from those of the first embodiment will be mainly described.

In the following description and drawings, a vertical direction when the image forming apparatus 1 is installed on a horizontal plane will be referred to as an up-down direction, and is illustrated by an up-down arrow V. A horizontal direction when the image forming apparatus 1 is installed on the horizontal plane, which is a direction orthogonal to a rotation axis direction of a photosensitive drum 61 included in the image forming apparatus 1, will be referred to as a horizontal direction, and is illustrated by a left-right arrow H. One side in the horizontal direction (a side on which a door 1D is disposed, a right side in FIG. 1) will be referred to as “front” or “front side”, and the other side in the horizontal direction will be referred to as “rear” or “rear side”.

The image forming apparatus 1 includes an apparatus body 1A, a scanner 2 serving as an exposing unit, a door 1D serving as an opening/closing member, a sheet feeding unit 130, a transfer unit 40, a cartridge tray unit 50, a fixing device 80, and a control unit 35.

In the present embodiment, the apparatus body 1A refers to a portion excluding the door 1D, the scanner 2, the sheet feeding unit 130, the transfer unit 40, the cartridge tray unit 50, the fixing device 80, and the control unit 35 from the image forming apparatus 1. The door 1D is an opening/closing member provided to be openable and closable with respect to the apparatus body 1A. The door 1D is movable between a closed position where the door 1D closes an opening 1A1 (opening portion) of the apparatus body 1A and an opened position where the door 1D opens the opening 1A1.

A door sensor 91 for detecting whether the door 1D is opened or closed is disposed in the apparatus body 1A. The door sensor 91 is configured such that an output signal of the door sensor 91 differs between a state where the door 1D is at the closed position and a state where the door 1D is at the opened position. The sheet feeding unit 130 includes a stacking tray 131 (sheet storage unit, cassette) on which the recording material S is stacked, a feed roller 132 serving as a feeding member, and a separation roller that forms a separation nip with the separation roller and the feed roller 132.

The cartridge tray unit 50 includes a tray 51 and cartridges PY, PM, PC, and PK. The tray 51 is a support member that supports the cartridges PY to PK. The tray 51 is a drawer unit that is inserted into the apparatus body 1A in a drawable manner.

The cartridges PY, PM, PC, and PK contain toners (developers) of yellow (Y), magenta (M), cyan (C), and black (K), respectively. The cartridges PY, PM, PC, and PK have the same configuration except that the colors of the contained toners are different. Therefore, the configuration and operation of one of the cartridges PY, PM, PC, and PK will be described, and description of the other cartridges may be omitted. In addition, when it is not necessary to distinguish the cartridges PY, PM, PC, and PK, any one of the cartridges PY, PM, PC, and PK may be simply referred to as a cartridge P.

The cartridge tray unit 50 includes four photosensitive drums 61 serving as image bearing members, four charging rollers 62 serving as charging members, and four developing rollers 71 serving as developer bearing members or developing members. The cartridge tray unit 50 includes four cleaning blades serving as cleaning members. The rotation axis direction of the photosensitive drum 61, the rotation axis direction of the developing roller 71, and the rotation axis direction of the charging roller 62 are parallel.

The photosensitive drum 61, the charging roller 62, the developing roller 71, and the cleaning member may be provided in either the cartridge P or the tray 51. That is, the cartridge P including at least one member selected from the group including the photosensitive drum 61, the charging roller 62 (charging member), the developing roller 71 (developing member), and the cleaning member is an example of a “unit” in the present disclosure. In the present embodiment, each of the cartridges PY, PM, PC, and PK includes one photosensitive drum 61, one charging roller 62, one developing roller 71, and one cleaning member.

The transfer unit 40 includes a transfer belt 41 serving as an intermediate transfer member, four primary transfer rollers 42, a cleaning unit 43, a driving roller 46 that drives the transfer belt 41, and a tension roller (driven roller) 47. In addition, the image forming apparatus 1 according to the present embodiment includes an optical sensor 44 that detects a toner image transferred to the transfer belt 41. In the present embodiment, the transfer belt 41 is disposed under the four photosensitive drums 61, and abuts on the photosensitive drums 61 such that a primary transfer portion is formed between the transfer belt 41 and the photosensitive drums 61.

In addition, the image forming apparatus 1 includes a secondary transfer roller 45 that abuts on the transfer belt 41 to form a secondary transfer portion. The rotation axis direction of the primary transfer roller 42, the rotation axis direction of the driving roller 46, the rotation axis direction of the tension roller 47, and the rotation axis direction of the secondary transfer roller 45 are parallel to each other. A registration roller pair 4 is disposed before the secondary transfer portion (upstream in the sheet conveyance direction).

The fixing device 80 includes a fixing unit 81 and a reversing unit 5. The fixing unit 81 includes a rotary member pair that nips and conveys the recording material S, and a heating unit that heats a toner image on the recording material S. In the present embodiment, the rotary member pair is a roller pair including a heating roller (fixing roller) and a pressurizing roller, and the heating unit is a halogen lamp that heats the heating roller. As rotating members constituting the rotary member pair, a cylindrical film or an endless belt stretched around a plurality of rollers may be used. In addition, the heating unit may be a heater substrate in which a pattern of a heating element is printed on a ceramic substrate, or a coil unit for heating a conductive layer in the heating roller or the film by induction heating. The reversing unit 5 includes a reverse conveyance roller pair that reversely conveys the recording material S to perform double-sided printing, and a guide unit that guides the recording material S having passed through the fixing unit 81 to the sheet discharge roller pair or the reverse conveyance roller pair.

Relationship between Cartridge Tray Unit and Fixing Device

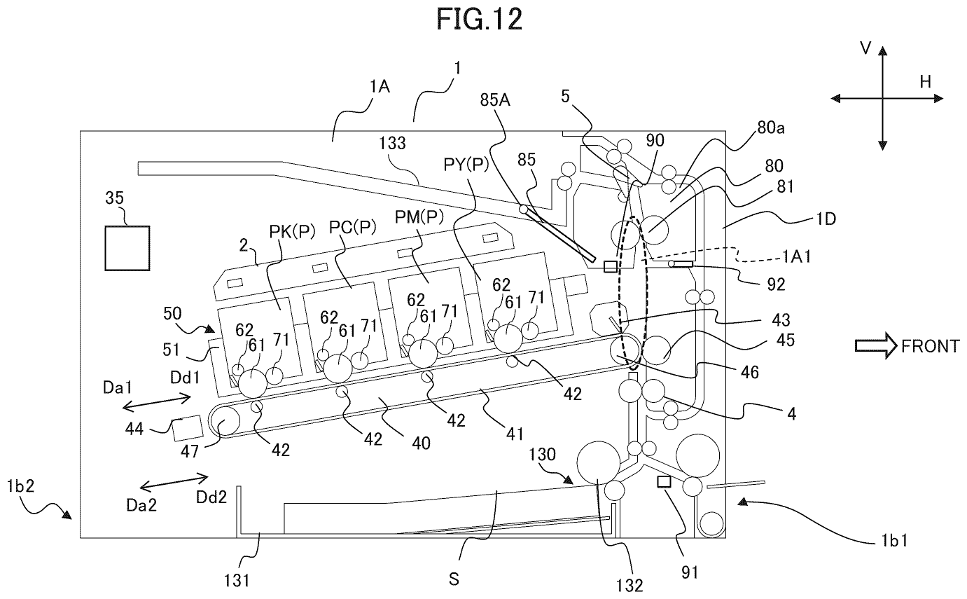

Next, the movement of the cartridge tray unit 50 in the present embodiment will be described with reference to FIG. 12. The cartridge tray unit 50 is movable from the inside to the outside of the apparatus body 1A. The apparatus body 1A has a first end 1b1 (heading edge) where the opening 1A1 is provided, and a second end 1b2 (trailing edge) opposite to the first end 1b1. The cartridge tray unit 50 is movable through the opening 1A1 between an inner position where the cartridge tray unit 50 is accommodated inside the apparatus body 1A and an outer position where the cartridge tray unit 50 protrudes outside the apparatus body 1A. The inner position is a position of the cartridge tray unit 50 when the image forming apparatus 1 executes an image forming operation. The outer position is a position of the cartridge tray unit 50 where the cartridge P is allowed to be attached to or detached from the tray 51. The cartridge tray unit 50 of the present embodiment can be detached toward the front side of the image forming apparatus 1 and attached toward the rear side of the image forming apparatus 1 in the horizontal direction (H).

The direction in which the cartridge tray unit 50 moves from the inner position to the outer position will be referred to as a tray detachment direction Dd1, and the direction opposite to the tray detachment direction Dd1 will be referred to as a tray attachment direction Da1. The tray detachment direction Dd1 can be referred to as a direction from the second end 1b2 toward the first end 1b1. The fixing device 80 is disposed on one end side (the side on which the first end 1b1 is disposed) of the apparatus body 1A in the horizontal direction.

The transfer unit 40 is movable from the inside to the outside of the apparatus body 1A. The transfer unit 40 is movable through the opening 1A1 between an inner position where the transfer unit 40 is accommodated inside the apparatus body 1A and an outer position where the transfer unit 40 protrudes outside the apparatus body 1A. The inner position is a position of the transfer unit 40 when the image forming apparatus 1 executes an image forming operation. The direction in which the transfer unit 40 moves from the inner position to the outer position will be referred to as a transfer detachment direction Dd2, and the direction opposite to the transfer detachment direction Dd2 will be referred to as a transfer attachment direction Da2. The transfer detachment direction Dd2 can be referred to as a direction from the second end 1b2 toward the first end 1b1.

### Image Forming Operation

Next, an image forming operation of the image forming apparatus 1 in the present embodiment will be described with reference to FIG. 12. The image forming operation is a series of operations by which the image forming apparatus 1 forms an image on the recording material S while conveying the recording material S one sheet at a time. In the image forming operation, the photosensitive drums 61 and the transfer belt 41 are rotationally driven. The charging roller 62 receives a charging voltage, and uniformly charge the surface of the corresponding photosensitive drum 61. The scanner 2 irradiates each of the photosensitive drums 61 with laser light corresponding to image information to expose the surface of each of the photosensitive drums 61. As a result, an electrostatic latent image corresponding to the image information is formed on the surface of each of the photosensitive drums 61.

The developing roller 71 carries toner and supplies the toner to the corresponding photosensitive drum 61. A developing voltage is applied to the developing roller 71, and the electrostatic latent image formed on the corresponding photosensitive drum 61 is developed by the toner supplied from the developing roller 71. As a result, a toner image is formed on the surface of each of the photosensitive drums 61. In the present embodiment, a contact developing method in which development is performed in a state where the developing roller 71 abuts on the corresponding photosensitive drum 61 is used, but a jumping developing method in which development is performed in a state where there is a gap between the developing roller 71 and the corresponding photosensitive drum 61 may be used.

When a full-color image is formed, a toner image of each color is formed on each of the photosensitive drums 61. The toner image of each color formed on each of the photosensitive drums 61 is transferred onto the transfer belt 41 by the corresponding primary transfer roller 42, and is conveyed toward the secondary transfer portion formed between the transfer belt 41 and the secondary transfer roller 45. The toner that has not been transferred to the transfer belt 41 is removed from the photosensitive drum 61 by the cleaning member.

On the other hand, in the sheet feeding unit 130, one sheet of recording material S is fed from a bundle of recording material S stacked on the stacking tray 131 by the feed roller 132 and the separation roller, and is conveyed toward the secondary transfer portion. In the secondary transfer portion, the toner image is transferred from the transfer belt 41 to the recording material S (secondary transfer). The toner that has not been transferred to the recording material S is removed from the transfer belt 41 by a cleaning blade 43A serving as a cleaning member provided in the cleaning unit 43.

The recording material S to which the toner image has been transferred in the secondary transfer portion is conveyed to the fixing device 80. The fixing unit 81 fixes the toner image onto the recording material S by heating and pressurizing the toner image on the recording material S while conveying the recording material S nipped at the nip portion (fixing nip) of the rotary member pair. The recording material S that has passed through the fixing nip is discharged to a sheet discharge tray 133 provided on an upper surface of the apparatus body 1A by the sheet discharge roller pair of the reversing unit 5.

In the case of double-sided printing in which images are formed on both sides of the recording material S, the recording material S that has passed through the fixing nip in a state where an image is formed on a first surface is guided to the reverse conveyance roller pair of the reversing unit 5. Further, the recording material S is switched back by the reverse conveyance roller pair, and is conveyed back toward the secondary transfer portion via a duplex conveyance path formed inside the door 1D. Then, after an image is formed on a second surface of the recording material S while passing through the secondary transfer portion and the transfer nip for the second time, the recording material S is discharged to the sheet discharge tray 133 by the sheet discharge roller pair.

Relationship between Cartridge Tray Unit and Fixing Device

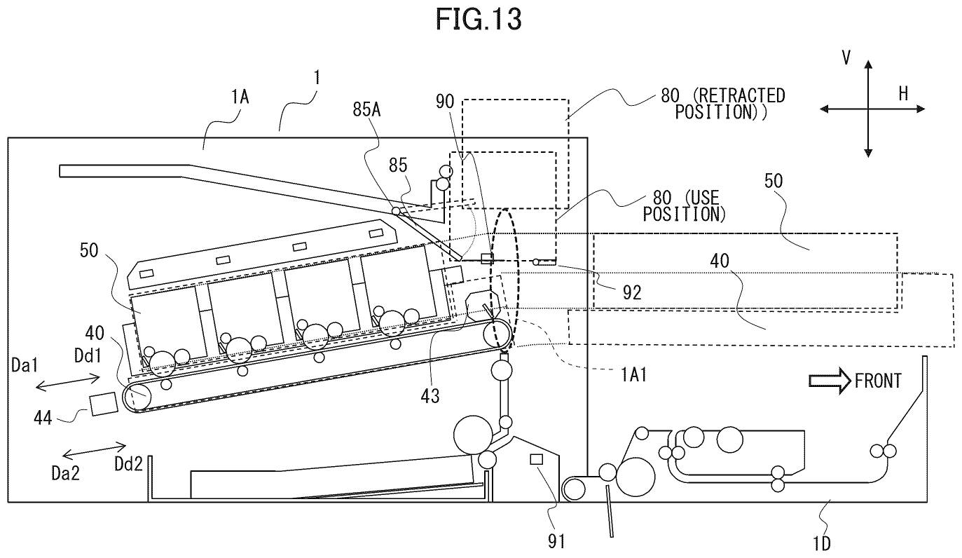

Next, a positional relationship between the cartridge tray unit 50 and the fixing device 80 in the present embodiment will be described with reference to FIG. 13. FIG. 13 illustrates the image forming apparatus 1 in a state where the door 1D is at an opened position, and also illustrates movement spaces of the cartridge tray unit 50 and the transfer unit 40 and a movement trajectory of the fixing device 80.

The cartridge tray unit 50 passes through a predetermined space when moving from the inner position to the outer position. This predetermined space will be referred to as a movement space or a movement trajectory of the cartridge tray unit 50. In addition, the space through which the transfer unit 40 passes when moving from the inner position to the outer position will be referred to as a movement space or a movement trajectory of the transfer unit 40.

In addition, the fixing device 80 is movable with respect to the apparatus body 1A between a use position (first position) and a retracted position (second position). The use position is a position of the fixing device 80 when the image forming apparatus 1 executes an image forming operation, that is, when the fixing device 80 performs a fixing operation of fixing an image on a recording material. The retracted position is a position where the fixing device 80 is retracted upward from the use position.

The use position of the fixing device 80 overlaps the movement space of the cartridge tray unit 50. That is, when the fixing device 80 is at the use position, at least a part of the fixing device 80 is inside the movement space of the cartridge tray unit 50. Therefore, in a state where the fixing device 80 is at the use position, the cartridge tray unit 50 is prevented from moving from the inner position to the outer position. That is, in the state where the fixing device 80 is at the use position, the cartridge P cannot be attached to or detached from the apparatus body 1A.

When the fixing device 80 is at the retracted position, the entire fixing device 80 is outside the movement space of the cartridge tray unit 50. Therefore, in the state where the fixing device 80 is at the use position, the cartridge tray unit 50 is allowed to move from the inner position to the outer position. That is, in a state where the door 1D is at the opened position and the fixing device 80 is at the retracted position (second position), the cartridge P (unit) is allowed to be attached to and detached from the apparatus body 1A.

The fixing device 80 includes a fixing frame member 80a that supports the fixing unit 81. When the fixing device 80 moves from the use position to the retracted position, the fixing frame member 80a is displaced with respect to the apparatus body 1A while supporting the fixing unit 81. In addition, the fixing frame member 80a forms an outer surface of the fixing device 80, and the movement space when the fixing device 80 moves between the use position and the retracted position is substantially the same as the movement trajectory of the fixing frame member 80a.

### Retraction Mechanism of Fixing Device

Next, a retraction mechanism of the fixing device 80 in the present embodiment will be described with reference to FIG. 13. In order to pull out the cartridge tray unit 50 to the outside of the apparatus body 1A, first, the door 1D is moved to the opened position. Next, the fixing device 80 is moved to the retracted position outside the movement space of the cartridge tray unit 50.

The image forming apparatus 1 includes a coupling member 85 (a fixing coupling member or a fixing link) movably coupled to the apparatus body 1A. The fixing device 80 is coupled to the apparatus body 1A via the coupling member 85. The coupling member 85 is rotatable about the rotation center 85A. When the cartridge tray unit 50 is pulled out to the outside of the apparatus body 1A, the coupling member 85 is moved to the outside of the movement space of the cartridge tray unit 50. The fixing device 80 is movable from the use position to the retracted position and from the retracted position to the use position in accordance with the movement of the cartridge tray unit 50 in a state where the fixing device 80 is supported by the coupling member 85.

In the present embodiment, the movement of the fixing device 80 to the retracted position is started by a user operation of an operation lever 92 serving as an operation unit. When receiving an instruction from the user by operating the operation lever 92, the control unit 35 rotates the coupling member 85 to move the fixing device 80 from the use position to the retracted position or from the retracted position to the use position. The operation lever 92 is disposed on the apparatus body 1A. For example, the control unit 35 drives a motor connected to the coupling member 85 to rotate the coupling member 85, thereby moving the fixing device 80. This motor functions as an actuator (driving unit) for moving the fixing device 80.

Note that the trigger for the retraction mechanism to move the fixing device 80 is not limited to the user operation of the operation lever 92. For example, the retraction mechanism may move the fixing device 80 in response to a user operation of a button on an operation panel. In addition, when the control unit 35 receives a user operation on an operation screen (driver screen) in an external host device communicably connected to the control unit 35 from the host device, the retraction mechanism may move the fixing device 80.

In addition, the mechanical configuration of the retraction mechanism of the fixing device 80 is not limited to what has been described above. For example, the fixing device 80 may be attached to a slide member that is vertically slidable, and a retraction mechanism that drives a pinion gear meshing with a rack portion of the slide member to be rotated by a motor may be used. Alternatively, the fixing device 80 may be supported in such a manner as to be slidable in a predetermined direction along a rail of the apparatus body 1A, and the user may manually move the fixing device 80 in the predetermined direction.

The position of the fixing device 80 in the present embodiment is detected by a retraction sensor 90 provided in the apparatus body 1A. The retraction sensor 90 is configured such that an output signal is different between a state in which the fixing device 80 is at the use position and a state in which the fixing device 80 is at the retracted position. That is, the retraction sensor 90 is a sensor that outputs a signal corresponding to the position of the fixing device 80.

As described above, in the present embodiment, the cartridge tray unit 50 is detached and the cartridge P is replaced in a state where the fixing device 80 is retracted from the use position to the retracted position.

In the present embodiment, the movement trajectory of the transfer unit 40 does not overlap the fixing device 80 at the use position. However, the transfer unit 40 may be detached and the transfer unit 40 may be replaced or maintained in a state where the fixing device 80 is retracted from the use position to the retracted position. In addition, the movement trajectory of the transfer unit 40 may be configured to overlap the fixing device 80 at the use position.

In addition, instead of the configuration in which the cartridge P is replaced or the like in a state where the fixing device 80 is at the retracted position, that is, in a state where the fixing device 80 is attached to the apparatus body 1A, the cartridge P may be replaced or the like in a state where the fixing device 80 is detached from the apparatus body 1A.

### Cartridge Replacement Procedure

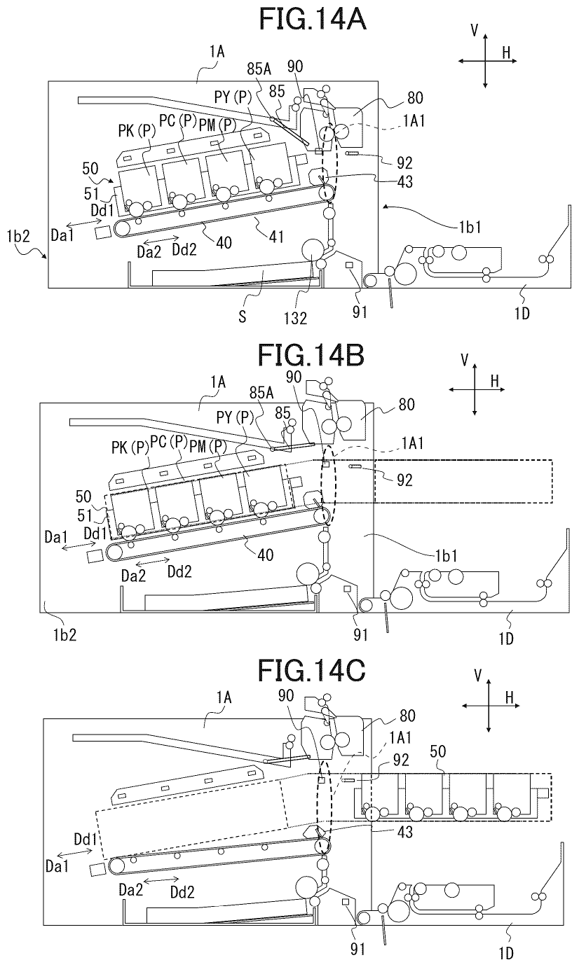

Next, a cartridge replacement procedure in the present embodiment will be described with reference to FIGS. 14A to 14C. FIG. 14A is a cross-sectional view of the image forming apparatus 1 in a state where the door 1D is opened. FIG. 14B is a cross-sectional view of the image forming apparatus 1 in a state where the fixing device 80 is retracted from the use position to the retracted position from the state of FIG. 14A. FIG. 14C is a cross-sectional view of the image forming apparatus 1 in a state where the cartridge tray unit is pulled out from the state of FIG. 14B.

In order to replace the cartridge P, first, the user moves the door 1D from the closed position to the opened position as illustrated in FIG. 14A. The control unit 35 detects that the door 1D has moved from the closed position to the opened position based on a signal of the door sensor 91.

Next, when the user operates the operation lever 92, the control unit 35 moves the fixing device 80 from the use position to the retracted position as illustrated in FIG. 14B. The control unit 35 detects that the fixing device 80 has moved from the use position to the retracted position based on a signal of the retraction sensor 90.

Next, as illustrated in FIG. 14C, the user pulls out the cartridge tray unit 50 from the inner position to the outer position of the apparatus body 1A. The user replaces a certain cartridge P of the cartridge tray unit 50. When the replacement of the cartridge Pis finished, the user pushes the cartridge tray unit 50 back from the outer position to the inner position (FIG. 14B).

After pushing back the cartridge tray unit 50, the user operates the operation lever 92. The control unit 35 moves the fixing device 80 from the retracted position to the use position (FIG. 14A). The control unit 35 detects that the fixing device 80 has moved from the retracted position to the use position based on a signal of the retraction sensor 90.

Finally, the user moves the door 1D from the opened position to the closed position. The control unit 35 detects that the door 1D has moved from the opened position to the closed position based on a signal of the door sensor 91. Thus, the replacement operation of the cartridge P is completed.

### Control Method

The image forming apparatus 1 of the present embodiment includes a drawer connector Cn1 and any one of body cables 100 to 300 similar to that of any one of the first to third embodiments. That is, the apparatus body 1A includes any one of the body cables 100 to 300 described in the first to third embodiments. The fixing device 80 includes a fixing-side connector 107 connected to the body-side connector 102 of the body cable included in the apparatus body 1A (for example, see FIG. 2). The drawer connector Cn1 includes a body-side connector 102 and a fixing-side connector 107.

In the present embodiment, when the fixing device 80 moves from the use position to the retracted position, the fixing-side connector 107 (second connector) is removed from the body-side connector 102 (first connector). In addition, when the fixing device 80 moves from the retracted position to the use position, the fixing-side connector 107 (second connector) is inserted into the body-side connector 102 (first connector). The drawer connector Cn1 may be inserted or removed by a link member that moves the fixing-side connector 107 or the body-side connector 102 in conjunction with the movement of the fixing device 80. In addition, the drawer connector Cn1 may be inserted or removed by a link member that operates in conjunction with the opening/closing member of the apparatus body 1A that is opened or closed when accessing the fixing device 27, or may be manually inserted or removed by a user.

The cutoff element 104 (fuse) described in the first or second embodiment may be provided in the body cable of the apparatus body 1A. In this case, the control unit 35 can execute control similar to that of the first or second embodiment, and can obtain advantages similar to those of the first or second embodiment.

In addition, the memory MM2 described in the third embodiment may be arranged in the fixing device 80. In this case, the control unit 35 can execute control similar to that of the third embodiment, and can obtain advantages similar to those of the third embodiment.

According to the present embodiment, it is possible to provide an image forming apparatus of a new form having a configuration capable of detecting a state of a connector.

### Other Modifications

In the above description, the fixing device has been mainly described as an example of a unit including a connector (second connector) that can be inserted into and removed from a connector (first connector) of an apparatus body. The present invention is not limited thereto, and the “unit” having the second connector may be any unit (e.g., the cartridge P in the embodiment) used in the image forming apparatus in a state where the unit is electrically connected to the apparatus body.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-039387, filed Mar. 13, 2024, which is hereby incorporated by reference herein in its entirety.

What is claimed is:

1. An image forming apparatus comprising:
an apparatus body including a control unit, and a wiring member electrically connected to the control unit, the wiring member having a first connector provided at an end of the wiring member; and
a unit including a second connector insertable into and removable from the first connector,
wherein the wiring member includes a fuse to be blown in accordance with a command from the control unit.

2. The image forming apparatus according to claim 1, further comprising:
a storage unit configured to store information related to a deterioration of the first connector,
wherein the control unit is configured to provide notification of information urging replacement of the wiring member based on the information.

3. The image forming apparatus according to claim 2, wherein
the information related to the deterioration of the first connector is the number of times the first connector and the second connector are inserted/removed after the fuse is blown.

4. The image forming apparatus according to claim 1, wherein
the control unit includes a detection circuit configured to output a signal corresponding to whether the fuse has been blown, and is configured to detect that the wiring member is new based on the signal of the detection circuit.

5. The image forming apparatus according to claim 4, wherein
in a case where the control unit detects that the wiring member is new, the control unit is configured to cause the fuse to be blown before the first connector and the second connector are inserted/removed.

6. The image forming apparatus according to claim 4, wherein
in a case where the control unit detects that the wiring member is new, the control unit is configured to cause the fuse to be blown after the first connector and the second connector are inserted/removed a predetermined number of times.

7. The image forming apparatus according to claim 1, wherein
the wiring member includes a third connector electrically connected to the control unit, and a wiring connecting a terminal of the first connector and a terminal of the third connector, and
the fuse is disposed in a middle of the wiring.

8. The image forming apparatus according to claim 1, wherein
the wiring member includes a third connector electrically connected to the control unit, and a looped wiring connecting terminals of the third connector to each other, and
the fuse is disposed in a middle of the looped wiring.

9. An image forming apparatus comprising:
an apparatus body including a control unit, and a first connector electrically connected to the control unit; and
a unit attachable to and detachable from the apparatus body, the unit including a second connector insertable into and removable from the first connector, and a storage unit configured to store information related to a deterioration of the second connector, the storage unit being electrically connected to the control unit via the first connector and the second connector.

10. The image forming apparatus according to claim 9, wherein
the information related to the deterioration of the second connector is the number of times of insertion/removal of the second connector.

11. The image forming apparatus according to claim 9, wherein
the control unit is configured to provide notification of information urging replacement of the unit based on the information related to the deterioration of the second connector.

12. The image forming apparatus according to claim 9, wherein
the apparatus body includes a second storage unit configured to store information related to a deterioration of the first connector.

13. The image forming apparatus according to claim 12, wherein
the apparatus body includes a wiring member with the first connector provided at an end thereof, and
the control unit is configured to provide notification of information urging replacement of the wiring member based on the information related to the deterioration of the first connector.

14. The image forming apparatus according to claim 1, wherein
the first connector and the second connector are drawer connectors.

15. The image forming apparatus according to claim 1, wherein
the first connector and the second connector are configured to be inserted and removed in a case where the unit is attached to and detached from the apparatus body.

16. The image forming apparatus according to claim 1, wherein
the first connector and the second connector are configured to be inserted/removed in a case where the unit is moved with respect to the apparatus body.

17. The image forming apparatus according to claim 1, wherein
the unit is a fixing device configured to fix an image formed on a recording material to the recording material.

18. The image forming apparatus according to claim 17, wherein
the fixing device includes a heating member configured to come in contact with the image on the recording material, a pressurizing member abutting on the heating member to form a nip portion between the heating member and the pressurizing member, and a heat source configured to heat the heating member, and the fixing device is configured to heat and pressurize the image while nipping and conveying the recording material at the nip portion.

19. The image forming apparatus according to claim 18, wherein
the heat source includes a heating element configured to be supplied an electrical current via the first connector and the second connector to generate Joule heat.

20. The image forming apparatus according to claim 17, further comprising:
a cartridge attachable to and detachable from the apparatus body,
wherein the fixing device is movable between a first position where the fixing device fixes the image on the recording material, and a second position retracted from the first position,
the cartridge is allowed to be attached to and detached from the apparatus body in a state where the fixing device is at the second position,
the second connector is removed from the first connector in a case where the fixing device is moved from the first position to the second position, and
the second connector is inserted into the first connector in a case where the fixing device is moved from the second position to the first position.
